(19) United States
(12) Patent Application Publication
(10) Pub. No.: US 2025/0363538 A1
(43) Pub. Date: Nov. 27, 2025

(54) ECOMMERCE PRODUCT MANAGEMENT USING INSTANT MESSAGING

(71) Applicant: Loop Now Technologies, Inc., San Mateo, CA (US)

(72) Inventors: Ka Ka Ng, Kwun Tong (HK); Ziming Zhuang, Palo Alto, CA (US)

(73) Assignee: Loop Now Technologies, Inc., San Mateo, CA (US)

(21) Appl. No.: 19/212,771

(22) Filed: May 20, 2025

Related U.S. Application Data
(60) Provisional application No. 63/649,966, filed on May 21, 2024.

(51) Int. Cl. G06Q 30/0601; G06Q 10/087; H04L 51/04

(52) U.S. Cl. CPC G06Q 30/0613; G06Q 10/087; G06Q 30/0633; H04L 51/04

(57) ABSTRACT

Techniques for inventory and product control are disclosed. An instant messaging (IM) system that recognizes an ecommerce business entity as a valid IM system identity is accessed. The IM system interfaces between one or more customers and the ecommerce business entity. The ecommerce business entity identity is bound to one or more back-office management systems. One or more products for sale are detected in an IM thread between the ecommerce entity and one or more customers. A product description page (PDP) based on the one or more detected products is created. A link to the PDP is provided to the ecommerce business entity. The ecommerce business entity sends the PDP link to the one or more customers. The IM system collects responses from the customers and manages products of the ecommerce business using the back-office management systems, including inventory, ordering, shipping, and transaction processing.

### RELATED APPLICATIONS

This application claims the benefit of U.S. provisional patent applications “Ecommerce Product Management Using Instant Messaging” Ser. No. 63/649,966, filed May 21, 2024.

The foregoing application is hereby incorporated by reference in its entirety.

### FIELD OF ART

This application relates generally to inventory product management and more particularly to ecommerce product management using instant messaging.

### BACKGROUND

Humans communicate with one another in many different ways. Some forms of communication are subtle and nuanced. Others are clear and direct. Some methods use hundreds, even thousands of words to put across an idea. Others are expressed in a painting, a photograph, a sculpture, or a song. We often speak without saying a word. Nonverbal expression relies heavily on facial expressions, from smiling to frowning, raised eyebrows, pursed lips, rolling eyes, or furrowed brows. Gestures with the hands, head nods or shakes, skips or dances can confirm or deny spoken words or speak volumes on their own. Eye contact including staring, looking away, sideways glances, or accompanied by tears can raise delight or heartbreak in others. The posture of the body can tell us of pride and courage, doubt, anger, fear, vulnerability, self-control, or a complete lack of control. A touch can be as gentle as a baby's finger or as harsh as a jaw-breaking punch. Nonverbals convey emotion and attitudes far better than words alone. They can reinforce or contradict a spoken message, and they can be effective when there are no words, or when speech cannot be heard. But nonverbal communication is also open to misinterpretation and confusion. Cultures assign different messages to similar nonverbal actions. Standing close to a person in one culture can communicate warmth and friendship, while in another it speaks aggression and intimidation. Nonverbals can take a long time to learn and the ability to use them effectively can vary widely. Actors, public speakers, and politicians practice nonverbal skills all their lives which can help to make them highly effective communicators, and yet at the same time they may be seen by some as less trustworthy. In general, we need both verbal and nonverbal skills to have the best chance of getting our messages across to others.

Verbal communication can take many variations, but it can essentially be reduced to verbal and written forms. For many, the spoken word holds great power. Verbal communication is often perceived as authentic and trustworthy. Speech allows for nuanced expressions, especially when coupled with strong nonverbal skills. Verbal communication can be nuanced, tailored for an audience, and adjusted on the fly. But it can also be easily misunderstood. Cultural differences, background, idiomatic expressions, and the immediate context can dramatically impact the ways in which verbal messages are received and understood. Humor is notoriously difficult to translate from one culture to another, as are other nuanced forms of verbal communication. Effective verbal communication requires the speaker to listen well and perceive nonverbal cues from those being spoken to, sometimes in the very midst of speaking a sentence.

Written communication has its own advantages and disadvantages. Writing can provide a permanent record for others to review and interpret. The process of writing gives the author a chance to consider their words and the message to be conveyed, although this opportunity is not always fully realized. The written word can be transmitted easily everywhere with case, especially in our modern times. However, it can be difficult to communicate tone and nuance in written communication. Without the communicator in the room delivering the message, the reader is free to impose his or her own understanding of words and phrases to sentences and paragraphs. Every form of communication requires work on both sides of the message. The one delivering must work to speak, write, or act out the message as clearly as possible, while the receiver must work just as hard to interpret the message as it was intended, using good follow-up to confirm what they have heard, read, or seen.

### SUMMARY

Effective communication skills can be shaped and enhanced by modern technology. Customers searching for the right products to buy and for information about those products are looking for sources that can deliver the right data quickly. Instant messaging (IM) has become more popular as a means of collecting product information. But IM systems can be limited in their ability to deliver thorough product information or to purchase goods and services once they have been located. In addition, merchants and support staff are still challenged to communicate with the customer effectively, especially using a message format designed to be pared down to the bare essentials. The business representative must know the product or service being discussed, know how to support it, and be able to communicate effectively with the customer. The relationship between the sales or support person and the customer must form quickly and engage the user in a positive manner. Understanding the customers' needs, addressing their concerns, and presenting the answers in an effective manner takes practice. The more quickly and reliably the correct information can be accessed and delivered, the better. As ecommerce business continues to expand sales and support demand, strong delivery mechanisms must grow to meet the need.

A computer-implemented method for product management is disclosed comprising: accessing an instant messaging (IM) system, wherein the IM system interfaces between one or more customers and an ecommerce business entity, and wherein the IM system recognizes the ecommerce business entity as a valid instant messaging system identity; binding the ecommerce business entity identity to one or more back-office management systems within the ecommerce business entity; detecting a product in an instant messaging thread between the ecommerce business entity and the one or more customers; creating a product description page (PDP) by at least one of the one or more back-office management systems, based on the detecting of a product; providing a PDP link for the PDP, by the at least one of the one or more back-office management systems, to the ecommerce business entity; sending the PDP link, by the ecommerce business entity, to the one or more customers, using the IM system; collecting one or more responses from the one or more customers, using the IM system; and managing products, by the ecommerce business, based on the PDP and one or more responses from the one or more customers, using the one or more back-office management systems. In embodiments, the back-office management system comprises an inventory management system. In embodiments, the inventory management system generates the PDP. In embodiments, the one or more responses include sharing about the product, commenting on the product, purchasing the product, reserving the product, inquiring about the product, and rating the product.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for ecommerce product management using instant messaging.

FIG. 2 is a flow diagram for product detection and inventory control using instant messaging.

FIG. 3 is an infographic for ecommerce product management using instant messaging.

FIG. 4 is an infographic for automatic inventory creation and order collection for instant messaging.

FIG. 5 is an infographic for processing product orders and customer information.

FIG. 6 is an infographic for automatic campaign page and link generation.

FIG. 7 is an example of a campaign page for multiple products.

FIG. 8 is a system diagram for ecommerce product management using instant messaging.

### DETAILED DESCRIPTION

Instant messaging systems have become immensely popular and can engage thousands or even millions of users. Ecommerce merchants have engaged IM systems to deliver information about their products, deliver support information, and sell goods and services. However, responding to customer questions and comments quickly and accurately can be difficult. Accessing the right information quickly and sending it back to the user who is looking for it can be the difference between a sale or a potential customer leaving the message stream. Understanding and responding to messages effectively and efficiently can be enormously challenging, even for professional sales and support staff people. Large language models (LLMs) including natural language processing (NLP) can help by monitoring the user interactions and generating sales information in a concise and efficient manner. As the volume of digital communication increases for sales and customer support, the uses of LLMs can help encourage rapid and accurate viewer engagement and increased sales.

Techniques for product management are disclosed. Ecommerce business users access an instant messaging (IM) system using one or more valid IM system identities. The ecommerce business user identities are bound to one or more back-office management systems, such as inventory management and order management systems, giving them access to information and application processes in these systems within the IM message stream. As the ecommerce business users interact with customers, the IM message stream is captured by one or more bots and analyzed by an LLM including natural language processing. Products offered for sale by the ecommerce business are detected by analyzing words and images appearing in the message stream. The one or more back-office systems are used to create a product description page (PDP) based on one or more products detected by the IM message stream bots. A link to the PDP is provided to the ecommerce business user. This allows the business representative to quickly access detailed information about the one or more products being discussed by the customer. The business representative can send the PDP to the customers as well, allowing them to review the information assembled by the back-office systems. As the customers respond to the product information provided by the PDP, additional steps can be taken within the message stream, including answering additional questions, purchasing products, arranging shipping, and so on. As orders are taken and processed, the inventory management system can be updated with product and quantity details. The ecommerce business user can also create campaign pages within the PDPs, so that multiple products can be presented to customers at the same time. This allows for more product information and sales opportunities to be delivered to the ecommerce business users and customers quickly and efficiently.

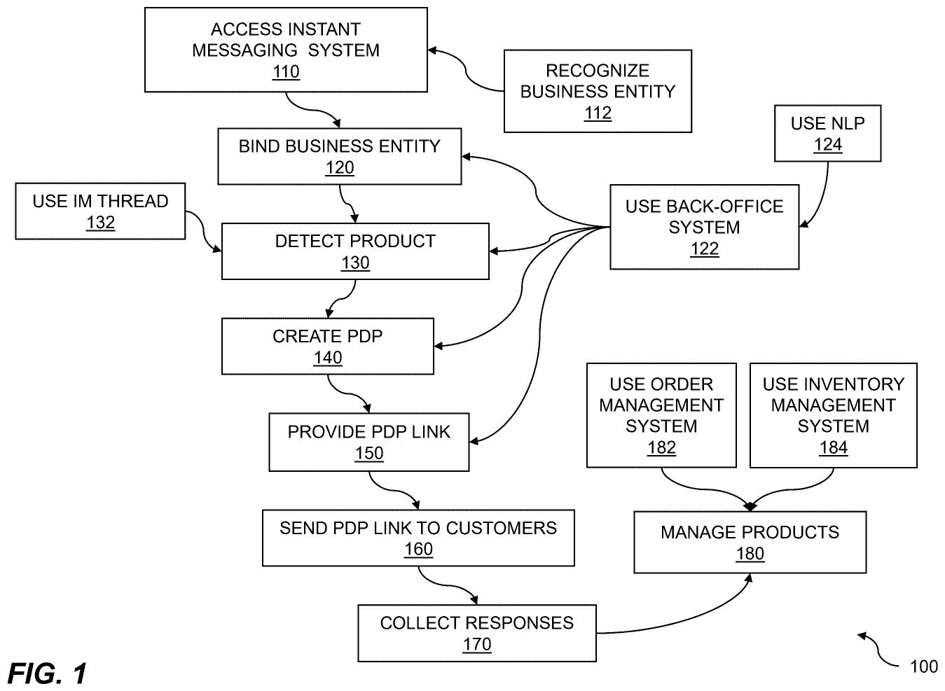

FIG. 1 is a flow diagram for ecommerce product management using instant messaging. The flow 100 includes accessing an instant messaging (IM) system 110, wherein the IM system interfaces between one or more customers and an ecommerce business entity, and wherein the IM system recognizes the ecommerce business entity 112 as a valid instant messaging system identity. Instant messaging (IM) is a type of online chat that allows users to communicate in real time via the Internet or an intranet. IM systems can use text messages, emojis, files, voice calls, and video calls. IM systems can use standalone applications or can be embedded in other software programs. In embodiments, the IM system can operate on a website. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser running on the device. In embodiments, the IM system comprises an app running on a mobile device. The app can use HTTP, TCP/IP, or DNS to communicate with the Internet, web servers, cloud-based platforms, and so on. In embodiments, the ecommerce business entity can establish one or more identities that can be recognized on the IM system. For example, the ecommerce business can create an IM identity for its client services department, another for the sales department, and another for shipping or fulfillment services. Another ecommerce entity can establish a single IM system identity to represent multiple facets of its business to customers. Each IM system identity can access the same features and functions available in the IM system as a regular user.

In embodiments, the IM system can include a controller bot. The controller bot can interact with the ecommerce business entity using the one or more identities recognized by the IM system. The controller bot can receive commands for the IM system and can apply system updates. The controller bot can upload photos, videos, and other files generated by the business entity and make them available to customers as part of IM system message threads. The controller bot can pass commands through the IM system to an inventory management system and/or an order management system. In embodiments, photos and videos can be generated on a device used by the ecommerce business entity using a camera included on the device.

The flow 100 includes binding 120 the ecommerce business entity identity to one or more back-office management systems 122 within the ecommerce business entity. The one or more back-office management systems can utilize or contain a large language model (LLM) artificial intelligence system. In embodiments, the back-office management system comprises an inventory management system. The inventory management system can include information about products available for purchase from the ecommerce business entity. The information can include product descriptions; specifications; product comments by users, experts, and social media influencers; purchasing details; instructions for reservations; inquiry processing; and product ratings. The inventory management system can include photos and videos of products. The flow 100 further comprises suggesting, by the one or more back-office systems, a product description, based on the detecting. As new products are added to the ecommerce business, the product information collected by the back-office systems can be used to assemble product descriptions as items are added to the product knowledgebase.

In embodiments, the one or more ecommerce business IM identities can be set up as one or more users in the inventory management system. The IM system can be established as an input/output connection to the inventory management system, so that the IM system can be used to submit inquiries to and receive responses from the inventory management system. In some embodiments, one or more proxy users can be established in the inventory management system so that customers in the IM system can submit inquiries to the inventory management system directly.

In embodiments, the back-office management system comprises an order management system. The order management system can include information about customers such as contact information, shipping addresses, product information, quantity information, and so on. In embodiments, the order management system can interface to the inventory management system so that updates can be sent to the inventory management system when order information is collected. In embodiments, the one or more ecommerce business IM identities can be set up as one or more users in the order management system. The IM system can be established as an input/output connection to the order management system, so that the IM system can be used to submit inquiries to and receive responses from the order management system. In some embodiments, one or more proxy users can be established in the order management system so that customers in the IM system can submit inquiries to the order management system directly.

The flow 100 includes detecting 130 a product in an instant messaging thread 132 between the ecommerce business entity and the one or more customers. In embodiments, the IM system can include a store bot. The store bot is an application included in the IM system 110. In embodiments, the store bot monitors the one-to-one and group message threads on the IM system and sends the thread contents to a machine learning model for analysis by one or more LLMs. In embodiments, the IM message thread can be analyzed by a machine learning system that includes a large language model. A large language model (LLM) is a type of machine learning model that can perform a variety of natural language tasks, including generating and classifying text, answering questions in a human conversational manner, and translating text from one language to another. The LLM can be trained with voice and text interactions between users, human sales associates, help desk staff members, and product experts. Information articles and questions covering products and services offered for sale by the ecommerce business can be included in the LLM database. In embodiments, the LLM can use a natural language processing (NLP) engine 124. NLP is a category of machine learning concerned with interactions between humans and computers using natural human language. NLP can be used to develop algorithms and models that allow computers to understand, interpret, generate, and manipulate human language. In embodiments, the large language model (LLM) uses NLP to understand the text and the context of messages in the IM interactions between the ecommerce business entity and customers. NLP can be used to evaluate a context of the interaction including determining a topic of discussion; understanding references to and information from other websites; demonstrating products for sale or product brands; and evaluating livestream hosts associated with a brand, product for sale, or topic. Each IM messaging thread can be analyzed by the LLM and can be used to recognize references to products and services offered for sale. In embodiments, the instant messaging thread is detected based on a photo of the product included in the thread. In some embodiments, the detecting is based on a product photo, a product video, or a product description. Metadata associated with product photos or videos can be used by the LLM to recognize references to products or services for sale by the ecommerce business entity.

The flow 100 includes creating 140 a product description page (PDP) by at least one of the one or more back-office management systems, based on the detecting of a product. In embodiments, the inventory management system generates the PDP. The PDP can include additional product details. The additional product details can include one or more of a name of the product, a description of the product, a price of the product, an availability of the product, a variation of the product, and an alternative to the product. In embodiments, the PDP is created by the inventory management back-office system. The PDP can contain multiple product photos or videos, product descriptions, specifications, dimensions, shipping times, and so on. In embodiments, product information from the order management system and the inventory management system can be combined into a PDP template. The PDP template can be included in both management systems so that details from both can be included in a PDP generated by either system. In embodiments, the PDP can include photos, product details, videos, pricing, shipping, lead times, alternate products, related products, and so on. The PDP can include hypertext and links to external websites or web pages on the ecommerce business website.

The flow 100 includes providing a PDP link 150 for the PDP, by the at least one of the one or more back-office management systems, to the ecommerce business entity. In embodiments, the PDP can be provided to the ecommerce business entity as a link, a PDF, a file, and so on. The PDP can include links to the back-office order management system, the inventory management system, or both. For example, a sales representative for the ecommerce business entity can mention a product for sale as part of an IM message thread discussion with a customer. The LLM can recognize the reference to the product and automatically generate a PDP including all information related to the product available from the ecommerce business order management and inventory management systems, and can send the PDP to the sales representative. The PDP can appear as a link, a PDF document, or a file in the IM messaging system. The sales representative can click on the PDP link, document, or file and use the product information to continue the interaction with the customer. In some embodiments, opening the PDP can automatically open the sales representative's access to the order management system and/or the inventory management system to allow for additional interaction with these systems. In cases where the sales representative is already accessing the back-office systems, the embedded links in the PDP can direct the back-office systems to the screens or pages containing information related to the product highlighted by the PDP.

The flow 100 includes sending 160 the PDP link, by the ecommerce business entity, to the one or more customers, using the IM system. In embodiments, the ecommerce business entity can use the product information contained in the PDP to continue the interaction with the customer as well as forward the PDP link to the one or more customers. The sales representative or customer support person can send and receive IM messages as the customer views the PDP information, answer questions, clarify details in the PDP, and so on. In embodiments, the PDP can comprise multiple products. The multiple products can comprise a campaign theme, wherein the campaign theme is created by the one or more back-office systems. For example, a sales representative or customer can reference hiking boots in an IM message thread. The PDP generated in response can include information on hiking boots, and related socks, shorts, shirts, jackets, hats, and so on. The campaign theme related to hiking apparel can be generated by the ecommerce business entity in advance and can be entered into the back-office systems or generated by the back-office systems automatically as customer demand for groups of products are recognized by the LLM machine learning model. In some embodiments, discounts or other sales incentives can be included in the PDP. For example, purchasing a bundle of products that includes hiking boots, socks, pants and a shirt or jacket results in a ten percent discount on the price of the entire set of products when purchased together. In embodiments, the multiple product PDP is based on more than one response in the IM message thread. For example, a customer can reference kitchen knives, running shoes, and a new DVD title during an IM message exchange. A multiple product PDP containing information on all three items can be generated and forwarded to the ecommerce sales representative, allowing the representative to discuss any of the products and allowing the customer to decide which products to pursue. In some embodiments, the multiple product PDP can include discount information related to one or more of the products included in the PDP. For example, a sales campaign related to kitchen knives can be included in the PDP, or a five percent discount can be offered for all items in a single order totaling over one hundred and fifty dollars, etc.

The flow 100 includes collecting 170 one or more responses from the one or more customers, using the IM system. The user can respond to the ecommerce business entity by typing a question or comment into the IM system. The comment can be in the form of an emoji. The one or more responses include sharing about the product, commenting on the product, purchasing the product, reserving the product, inquiring about the product, and rating the product. The user input can comprise video input collected by the IM system. The video input can include audio input which can be analyzed, recorded, and/or transformed by a speech-to-text converter. In embodiments, the order management system collects an order from the one or more responses. The order can be based on a reply, included in the one or more responses, to the PDP link. The reply can be processed by natural language processing (NLP). The IM messaging stream can be analyzed by the LLM as the interaction between the ecommerce business entity and the customer continues. As mentioned above, the IM messaging stream can include emoji comments along with other text, which can all be analyzed by the LLM.

The reply from the customer can contain an order for one or more products contained in the PDP. The order can be based on a copy/paste, included in the one or more responses, detailing customer contact information, product information, and quantity information. The IM message stream can include information from the ecommerce business entity that contains exact details regarding how to purchase an item. The customer can copy the order details and paste them into a reply in the IM system in order to complete a purchase. In embodiments, the one or more responses from the customer can initiate a transaction by an order management back-office system. The transaction can be a purchase, an exchange, a return, and so on. In some embodiments, the transaction can be completed using a template included in the IM message thread that propagates data into the order management system. The order management system can further comprise confirming, through the IM system, any product order contained in the one or more responses. In embodiments, the customer can respond with a request for additional information, ask for a reminder to review the product at a later time, inquire about a different product, look for additional or alternate discounts, and so on. The ecommerce business entity can in turn respond with additional information, receive additional PDPs generated by the back-office systems, and so on in order to keep the interaction with the customer flowing.

The flow 100 includes managing 180 products, by the ecommerce business, based on the PDP and one or more responses from the one or more customers, using the one or more back-office management systems. The back-office management systems can comprise an order management system 182 or an inventory management system 184, to name just a few possible back-office management systems. In embodiments, the one or more back-office systems can provide a checkout link, based on the one or more responses in the instant messaging thread. Based on the one or more back-office systems bound to the ecommerce business entity identity, one or more products included in the PDP can be purchased or scheduled for later purchase. Quantities, sizes, dimensions, specifications and so on can be entered into the order management or inventory management system as determined by the ecommerce business. Delivery and shipping information can be entered, pricing can be finalized, and payment can be made within the IM messaging system, based on the binding to the back-office systems. In embodiments, the message thread is recorded by the LLM system for analysis and training in order to refine the contents of the PDPs, improve interactions with the customers, and suggest sales campaign themes to the ecommerce business.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

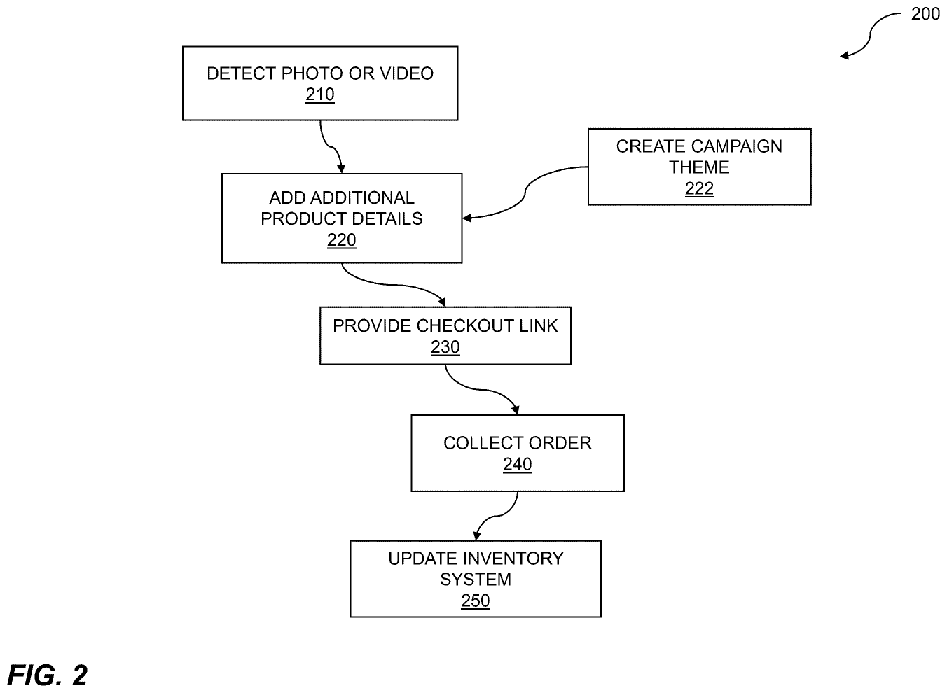

FIG. 2 is a flow diagram for product detection and inventory control using instant messaging. The flow 200 includes detecting a product in an instant messaging (IM) thread between the ecommerce business entity and the one or more customers. In embodiments, the IM message thread can be analyzed by a machine learning system that includes a large language model. The LLM can be trained with voice and text interactions between users, human sales associates, help desk staff members, and product experts. Information articles and questions covering products and services offered for sale by the ecommerce business can be included in the LLM database. In embodiments, the large language model (LLM) uses natural language processing (NLP) to understand the text and the context of messages in the IM interactions between the ecommerce business entity and customers. NLP can be used to evaluate a context of the interaction, including determining a topic of discussion; understanding references to and information from other websites; demonstrating products for sale or product brands; and evaluating livestream hosts associated with a brand, product for sale, or topic. Each IM messaging thread can be analyzed by the LLM and can be used to recognize references to products and services offered for sale.

In embodiments, the instant messaging thread is detected based on a photo of the product included in the thread. The detecting 210 can be based on a product photo, a product video, or a product description. In embodiments, the detecting includes transcribing the product videos. The detecting can include extracting objects from the one or more photos or videos, wherein the extracting is accomplished by machine learning. In embodiments, the context can be saved in an LLM product knowledgebase. The product information within the product knowledgebase can be updated with information from text, video, audio, or other sources that relate to a product or service for sale by the ecommerce business. Photos and videos can be analyzed for product images and audio information that can be transcribed, analyzed, and stored separately, or included as metadata related to one or more related products. Photos of products included in print advertisements, magazines, websites, vendor publications, and so on can be used by the LLM. Metadata associated with product photos or videos can be used by the LLM to recognize references to products or services for sale by the ecommerce business entity.

In embodiments, the detecting further comprises adding 220, to the instant messaging thread, additional product details. The additional product details can include one or more of a name of the product, a description of the product, a price of the product, an availability of the product, a variation of the product, and an alternative to the product. In embodiments, the additional product details can include information from the back-office systems, vendor websites, product experts, ecommerce sales and support staff, social media outlets, and so on.

In embodiments, the detecting can include multiple products in the instant messaging thread. The multiple products can comprise a campaign theme. A campaign theme can include a set of products related to one another. For example, a sales representative or customer can reference snowboards in an IM message thread. The PDP generated in response can include information on snowboards, and related boots, gloves, pants, jackets, hats, and so on. The campaign theme related to snowboard equipment can be created by the ecommerce business entity in advance and can be entered into the back-office systems, or can be generated by the back-office systems automatically as customer demand for groups of products are recognized by the LLM machine learning model. In some embodiments, discounts or other sales incentives can be included in the PDP. For example, purchasing a bundle of products that includes a snowboard, boots, masks, and a jacket results in a ten percent discount on the price of the entire set of products when purchased together. In embodiments, the multiple product PDP is based on more than one response in the IM message thread. For example, a customer can reference kitchen knives, running shoes, and a new DVD title during an IM message exchange. A multiple product PDP containing information on all three items can be generated and forwarded to the ecommerce sales representative, allowing the representative to discuss any of the products and allowing the customer to decide which products to pursue. In some embodiments, the multiple product PDP can include discount information related to one or more of the products included in the PDP. For example, a sales campaign related to kitchen knives can be included in the PDP, or a five percent discount can be offered for all items in a single order totaling over one hundred and fifty dollars, etc. The campaign theme can be created 222 by the one or more back-office systems.

The flow 200 can further comprise providing, by the one or more back-office systems, a checkout link 230, based on the one or more responses in the instant messaging thread. The back-office management system can comprise an order management system. The order management system can collect 240 an order from the one or more responses. In embodiments, one or more products included in the PDP can be purchased or scheduled for later purchase. Quantities, sizes, dimensions, specifications, and so on can be entered into the order management or inventory management system as determined by the ecommerce business. Delivery and shipping information can be entered, pricing can be finalized, and payment can be made within the IM messaging system based on the binding to the back-office systems. The flow 200 further comprises updating 250 a back-office inventory management system, by the order management system, based on the order that was collected. The order management system can interface to the inventory management system so that updated information can be sent to the inventory management system when order data is collected. In some embodiments, the checkout link 230 can start a separate application window or webpage to collect order details, payment information, shipping preferences, and so on. In embodiments, the message thread is recorded by the LLM system for analysis and training in order to refine the contents of the PDPs, improve interactions with the customers, and suggest sales campaign themes to the ecommerce business.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

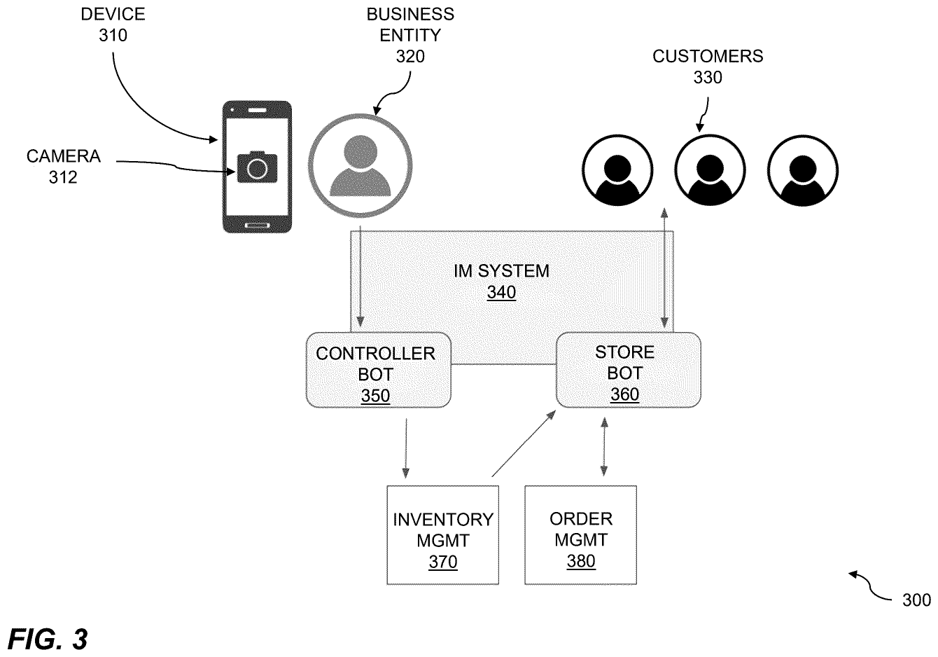

FIG. 3 is an infographic for ecommerce product management using instant messaging. The infographic 300 includes accessing an instant messaging (IM) system 340, wherein the IM system interfaces between one or more customers 330 and an ecommerce business entity 320, and wherein the IM system recognizes the ecommerce business entity as a valid instant messaging system ecommerce business entity identity. The IM system can operate on a website. The website can be an ecommerce site for a single vendor or brand, a group of businesses, a social media platform, and so on. In embodiments, the IM system can be displayed on a portable device 310. The portable device can be an Over-the-Top (OTT) device such as a mobile phone, laptop computer, tablet, or pad. The accessing of the IM system can be accomplished using a browser running on the device. In embodiments, the IM system comprises an app running on a mobile device. The app can use HTTP, TCP/IP, or DNS to communicate with the Internet, web servers, cloud-based platforms, and so on. In embodiments, the ecommerce business entity can establish one or more identities that can be recognized on the IM system. Each IM system identity can access the same features and functions available in the IM system as a regular user.

The infographic 300 includes a controller bot 350. The controller bot 350 is an application included in the IM system 340. The controller bot interacts with the ecommerce business entity 320 using the one or more identities recognized by the IM system. The controller bot can receive commands for the IM system and can apply system updates. The controller bot can upload photos, videos, and other files generated by the business entity and make them available to customers 330 as part of IM system message threads. The controller bot can pass commands through the IM system to an inventory management system 370 and/or an order management system 380. In embodiments, photos and videos can be generated on the device 310 using a camera 312 included on the device.

The infographic 300 includes a store bot 360. The store bot 360 is an application included in the IM system 340. In embodiments, the store bot 360 monitors one-to-one and group message threads on the IM system and sends the thread contents to a machine learning model for analysis by one or more LLMs. The store bot can also send links to the customers 330 with information on products sold by the ecommerce business entity 320.

In embodiments, the store bot 360 can detect a product in an instant messaging thread between the ecommerce business entity and the one or more customers. The detecting can be based on a product photo, a product video, or a product description. In embodiments, the detecting includes transcribing the product videos. The detecting can include extracting objects from the one or more photos or videos, wherein the extracting is accomplished by machine learning. In embodiments, the context can be saved in an LLM product knowledgebase. The product information within the product knowledgebase can be updated with information from text, video, audio, or other sources that relate to a product or service for sale by the ecommerce business. Photos and videos can be analyzed for product images and audio information that can be transcribed, analyzed, and stored separately, or included as metadata related to one or more related products. Photos of products included in print advertisements, magazines, websites, vendor publications, and so on can be used by the LLM.

Metadata associated with product photos or videos can be used by the LLM to recognize references to products or services for sale by the ecommerce business entity.

The infographic 300 includes binding the ecommerce business entity identity 320 to one or more back-office management systems within the ecommerce business entity. In embodiments, the back-office management system comprises an inventory management system 370. The inventory management system can include information about products available for purchase from the ecommerce business entity. The information can include product descriptions; specifications; product comments by users, experts, and social media influencers; purchasing details; instructions for reservations; inquiry processing; and product ratings. The inventory management system can include photos and videos of products. In embodiments, the one or more ecommerce business IM identities can be set up as one or more users in the inventory management system. The IM system can be established as an input/output connection to the inventory management system, so that the IM system can be used to submit inquiries to and receive responses from the inventory management system. In some embodiments, one or more proxy users can be established in the inventory management system so that customers in the IM system can submit inquiries to the inventory management system directly.

In embodiments, the back-office management system comprises an order management system 380. The order management system 380 can include information about customers such as contact information, shipping addresses, product information, quantity information, and so on. In embodiments, the order management system can interface to the inventory management system so that updates can be sent to the inventory management system when order information is collected. In embodiments, the one or more ecommerce business IM identities can be set up as one or more users in the order management system. The IM system can be established as an input/output connection to the order management system, so that the IM system can be used to submit inquiries to and receive responses from the order management system. In some embodiments, one or more proxy users can be established in the order management system so that customers in the IM system can submit inquiries to the order management system directly.

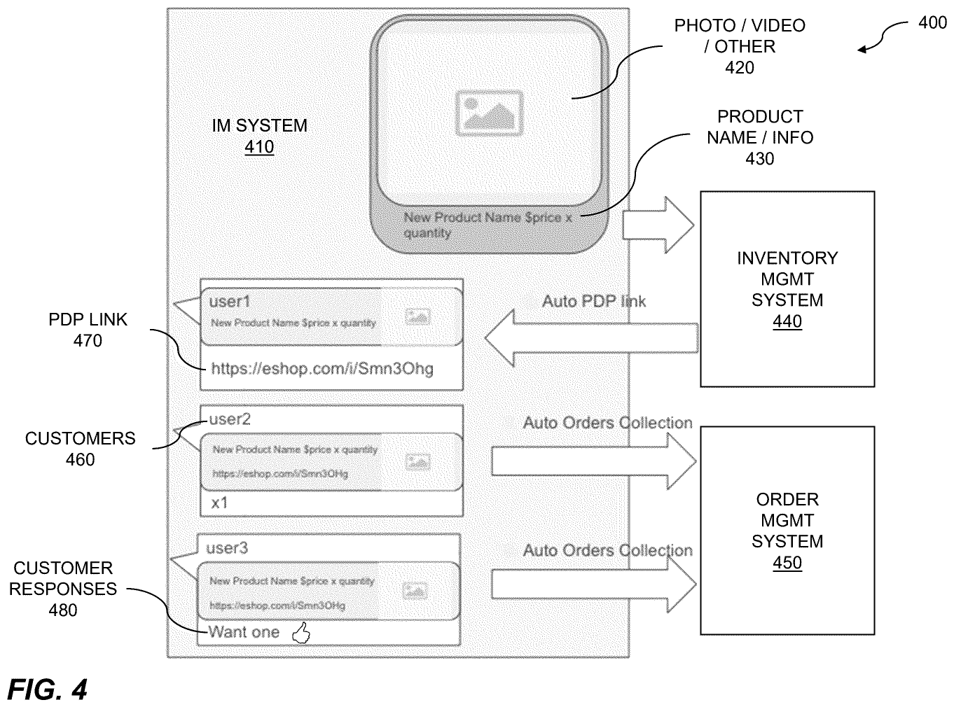

FIG. 4 is an infographic for automatic inventory creation and order collection for instant messaging. The infographic 400 includes accessing an instant messaging (IM) system 410, wherein the IM system interfaces between one or more customers 460 and an ecommerce business entity, and wherein the IM system recognizes the ecommerce business entity as a valid instant messaging system identity. In embodiments, the IM system can include a controller bot. The controller bot can interact with the ecommerce business entity using the one or more identities recognized by the IM system. The controller bot can receive commands for the IM system, and can apply system updates. The controller bot can upload photos, videos, and other files 420 generated by the business entity and make them available to customers 460 as part of IM system message threads. In embodiments, the ecommerce business entity can include product information in the IM message thread, such as product name, price, quantities, etc. The controller bot can also pass commands through the IM system to an inventory management system 440.

The infographic 400 includes detecting a product in an instant messaging thread between the ecommerce business entity and the one or more customers. In embodiments, the detecting is based on a product photo, a product video, or a product description. The detecting can include transcribing the product videos. The detecting can include extracting objects from the one or more photos, videos, and other files 420, wherein the extracting is accomplished by machine learning. In embodiments, the context can be saved in an LLM product knowledgebase. The product name and/or information 430 within the product knowledgebase can be updated with information, from text, video, audio, or other sources, that relates to a product or service for sale by the ecommerce business. Photos and videos can be analyzed for product images and audio information that can be transcribed, analyzed, and stored separately, or included as metadata related to one or more related products. Photos of products included in print advertisements, magazines, websites, vendor publications, and so on can be used by the LLM. Metadata associated with product photos or videos can be used by the LLM to recognize references to products or services for sale by the ecommerce business entity.

The infographic 400 includes creating a product description page (PDP) by at least one of the one or more back-office management systems, based on the detecting of a product. In embodiments, the inventory management system 440 generates the PDP. The PDP can include additional product details. The additional product details can include one or more of a name of the product, a description of the product, a price of the product, an availability of the product, a variation of the product, and an alternative to the product. The PDP can contain multiple product photos or videos, product descriptions, specifications, dimensions, shipping times, and so on. In embodiments, product information from the order management system 450 and the inventory management system 440 can be combined into a PDP template. The PDP template can be included in both management systems so that details from both can be included in a PDP generated by either system. In embodiments, the PDP can include photos, product details, videos, pricing, shipping, lead times, alternate products, related products, and so on. The PDP can include hypertext and links to external websites or web pages on the ecommerce business website.

The infographic 400 includes providing a PDP link 470 for the PDP, by the at least one of the one or more back-office management systems, to the ecommerce business entity. In embodiments, the PDP can be provided to the ecommerce business entity as a link 470, a PDF, a file, and so on. In some embodiments, the PDP can include links to the back-office order management system 450, the inventory management system 440, or both. In some embodiments, opening the PDP can automatically open the sales representative's access to the order management system and/or the inventory management system to allow for additional interaction with these systems. In cases where the sales representative is already accessing the back-office systems, the embedded links in the PDP can direct the back-office systems to the screens or pages containing information related to the product highlighted by the PDP.

The infographic 400 includes sending the PDP link 470, by the ecommerce business entity, to the one or more customers 460, using the IM system 410. In embodiments, the ecommerce business entity can use the product information contained in the PDP to continue the interaction with the customer as well as forward the PDP link to the one or more customers. The sales representative or customer support person can send and receive IM messages as the customer views the PDP information, answer questions, clarify details in the PDP, and so on. In embodiments, the PDP can comprise multiple products. The multiple products can comprise a campaign theme, wherein the campaign theme is created by the one or more back-office systems. In some embodiments, discounts or other sales incentives can be included in the PDP. In embodiments, the multiple product PDP is based on more than one response in the IM message thread. The multiple product PDP can include discount information related to one or more of the products included in the PDP.

The infographic 400 includes collecting one or more customer responses 480 from the one or more customers 460, using the IM system. In embodiments, the user can respond to the ecommerce business entity by typing a question or comment into the IM system. The response from the user can take the form of an emoji. The one or more responses include sharing about the product, commenting on the product, purchasing the product, reserving the product, inquiring about the product, and rating the product. In embodiments, the order management system can collect an order, based on the one or more responses. The order can be based on a reply, included in the one or more responses, to the PDP link. The reply can be processed by natural language processing (NLP). The IM messaging stream can be analyzed by the LLM as the interaction between the ecommerce business entity and the customer continues. The reply from the customer can contain an order for one or more products contained in the PDP. In embodiments, the one or more responses from the customer can initiate a transaction by an order management back-office system. The order management system can further comprise confirming, through the IM system, any product order contained in the one or more responses. In embodiments, the customer can respond with a request for additional information, ask for a reminder to review the product at a later time, inquire about a different product, look for additional or alternate discounts, and so on. The ecommerce business entity can respond with additional information, receive additional PDPs generated by the back-office systems, and so on in order to keep the interaction with the customer flowing.

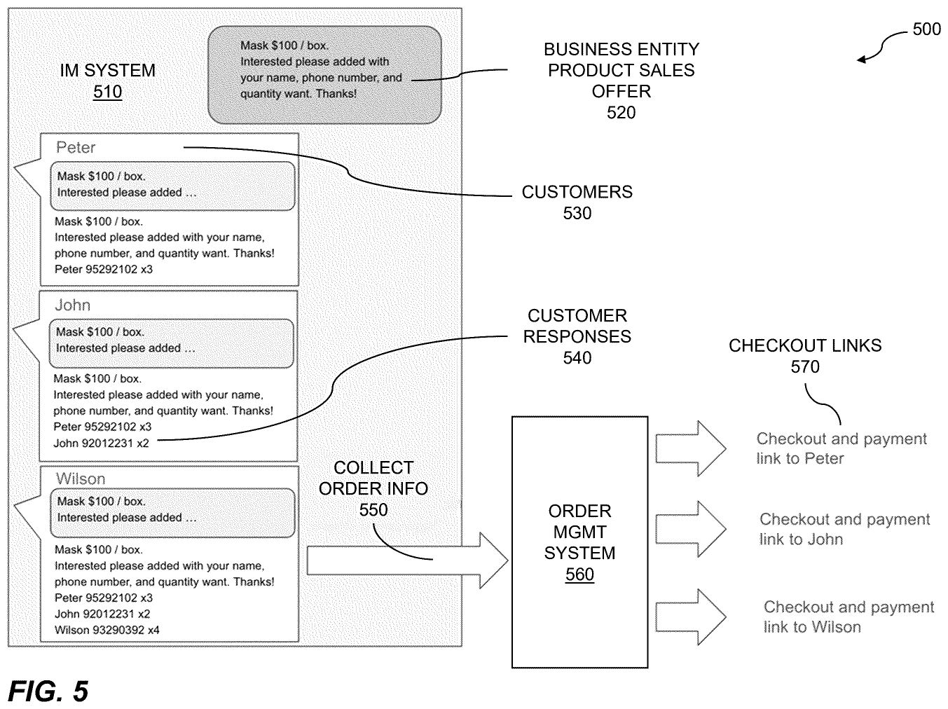

FIG. 5 is an infographic for processing product orders and customer information. The infographic 500 includes a business entity using a valid IM system 510 identity in an IM message thread to make a product sales offer 520 to one or more customers. In the example 500, the business entity offers masks for $100 per box. The offer includes instructions for the customer to use in reply in order to purchase one or more boxes of masks. The infographic 500 includes one or more customers 530 generating responses 540 to the product offer. In the example 500, there are three customers, Peter, John, and Wilson. Each customer receives the same IM message from the business entity. Each customer responds according to the instructions included in the offer from the business entity. In the example 500, each response contains the name of the customer, the customer phone number, and the number of boxes requested. John, for instance, replies “John 92012231×2”, indicating that the customer wants to purchase two boxes of masks.

The infographic 500 includes collecting one or more responses 540 from the one or more customers 530, using the IM system 510. The order management system 560 can collect order information 550 from the one or more responses customer responses 540. The order can be based on a reply, included in the one or more responses 540, to the PDP link, or to a direct offer from the business entity. The reply can be processed by natural language processing (NLP). The IM messaging stream can be analyzed by the LLM as the interaction between the ecommerce business entity and the customer continues. The reply from the customer can contain an order for one or more products contained in the PDP. In embodiments, the one or more responses from the customer can initiate a transaction by an order management back-office system 560. The order management system can further comprise confirming, through the IM system, any product order contained in the one or more responses. In embodiments, the customer can respond with a request for additional information, ask for a reminder to review the product at a later time, inquire about a different product, look for additional or alternate discounts, and so on.

The infographic 500 includes managing products, by the ecommerce business, based on the PDP and one or more responses 540 from the one or more customers 530, using the one or more back-office management systems. Checkout links 570 can be provided based on the responses. In embodiments, the one or more back-office systems can provide a checkout link, based on the one or more responses in the instant messaging thread. Based on the one or more back-office systems bound to the ecommerce business entity identity, one or more products included in the PDP can be purchased or scheduled for later purchase. Quantities, sizes, dimensions, specifications, and so on can be entered into the order management or inventory management system as determined by the ecommerce business. Delivery and shipping information can be entered, pricing can be finalized, and payment can be made within the IM messaging system based on the binding to the back-office systems. In embodiments, the message thread is recorded by the LLM system for analysis and training in order to refine the contents of the PDPs, improve interactions with the customers, and suggest sales campaign themes to the ecommerce business.

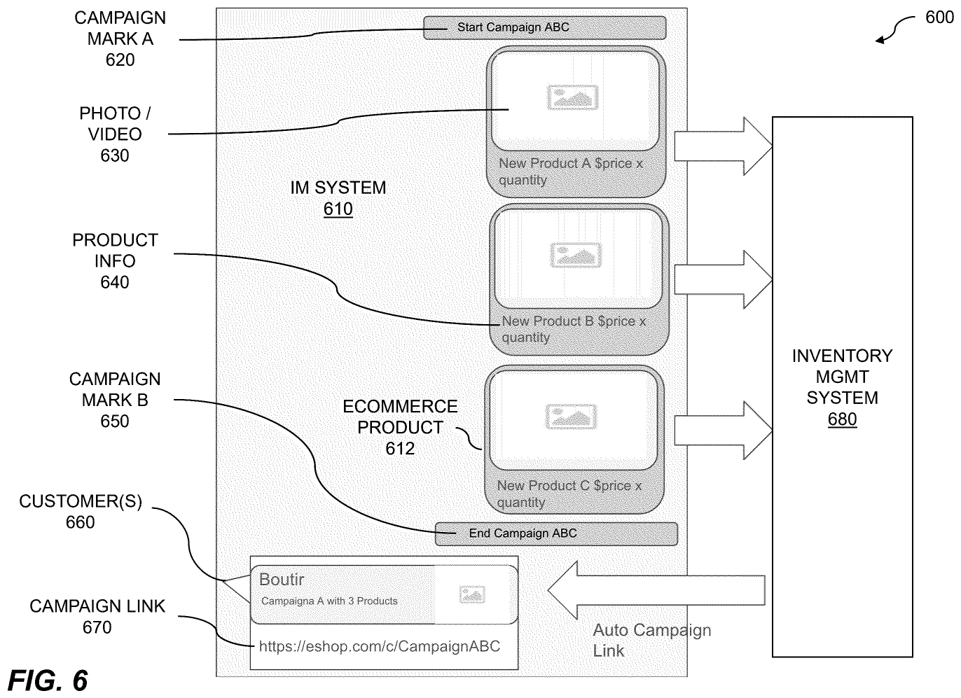

FIG. 6 is an infographic for automatic campaign page and link generation. The infographic 600 includes creating a product description page (PDP), by at least one of the one or more back-office management systems, based on the detecting an ecommerce product. In embodiments, an ecommerce business entity can use an IM system to message one or more customers. The IM message thread can include one or more ecommerce products for sale by the ecommerce business. The IM system can recognize the ecommerce business entity as a valid IM system identity. The business entity identity can be bound to one or more back-office management systems within the ecommerce business entity. In embodiments, the back-office management system comprises an inventory management system 680. The inventory management system can generate the PDP.

The infographic 600 includes multiple ecommerce business products 612. In embodiments, the multiple products can comprise a campaign theme, wherein the campaign theme is created by the one or more back-office systems. In the example 600, three products are selected to create an automatic campaign page. In embodiments, the ecommerce business entity can generate a campaign mark A 620 to generate a “start campaign” marker in the IM system. This mark can notify the IM message system that every subsequent product photo 630 and/or description 640 sent by the ecommerce business user can be included in a campaign page. In the example 600, three products, A, B, and C, are included in the campaign page. The example 600 includes a campaign mark B 650 to generate an “end campaign” marker in the IM system. In embodiments, the end campaign mark can be forwarded to the inventory management system 680 and can be used to start the creation of a campaign page and link. In some embodiments, the campaign theme can be generated by the ecommerce business entity in advance and then entered into the back-office systems, or generated by the back-office systems automatically as customer demand for groups of products are recognized by an LLM machine learning model. In some embodiments, discounts or other sales incentives can be included in the PDP.

The infographic 600 includes sending the PDP link 670, by the ecommerce business entity, to the one or more customers 660, using the IM system 610. As mentioned above and throughout, the multiple products can comprise a campaign theme, wherein the campaign theme is created by the one or more back-office systems. In some embodiments, discounts or other sales incentives can be included in the PDP. In embodiments, the multiple product PDP is based on more than one response in the IM message thread. For example, a customer can reference kitchen knives, running shoes, and a new DVD title during an IM message exchange. A multiple product PDP containing information on all three items can be generated and forwarded to the ecommerce sales representative, allowing the representative to discuss any of the products and allowing the customer to decide which products to pursue. In some embodiments, the multiple product PDP can include discount information related to one or more of the products included in the PDP.

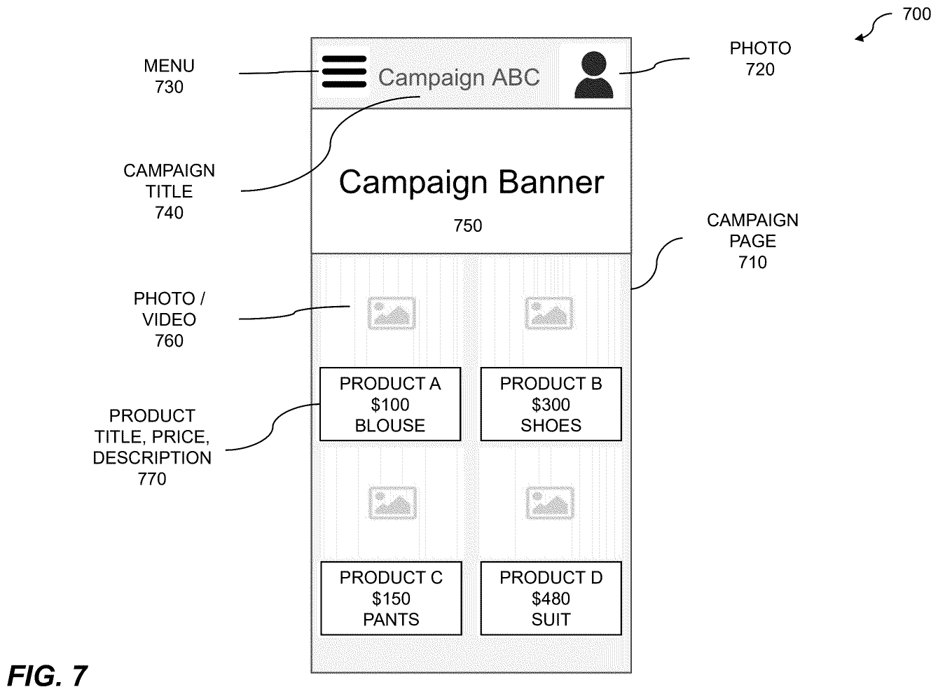

FIG. 7 is an example of a campaign page for multiple products. The example 700 includes a campaign page 710 comprising multiple products. The example 700 shows four products with pricing, Product A $100, Product B $300, Product C $150, and Product D $480. Each product can include a photo or video 760 and a product title, price, and/or description 770. The multiple products comprise a campaign theme. The campaign theme can be created by the one or more back-office systems. The back-office systems can include an inventory management system. The customer can select one or more products appearing on the campaign page using a mouse, pointer, or some other designator to indicate which of the one or more products to purchase. In some embodiments, the customer can click or point to the product title to display additional information about the product including pricing, quantity, description, shipping, and other details.

The example 700 includes a menu 730 for the campaign page 710. In embodiments, the menu can include options including closing the campaign page, forwarding the campaign page to other users, sending the ecommerce business entity a question or comment, purchasing all items, purchasing selected items, and so on. The example 700 includes a campaign title 740. In embodiments, the campaign title can be generated by the back-office system or by the ecommerce business entity creating the campaign page. The example 700 includes a photo 720. In embodiments, the photo 720 can be a digital photo, icon, avatar, etc. that represents the ecommerce business representative. The example 700 includes a campaign banner 750. In embodiments, the campaign banner can include a logo or digital image selected by the ecommerce business. In some embodiments, the digital image can be selected based on campaign options set in advance by the ecommerce business. The campaign banner can include photos, text, videos, instructions on how to purchase campaign items, etc.

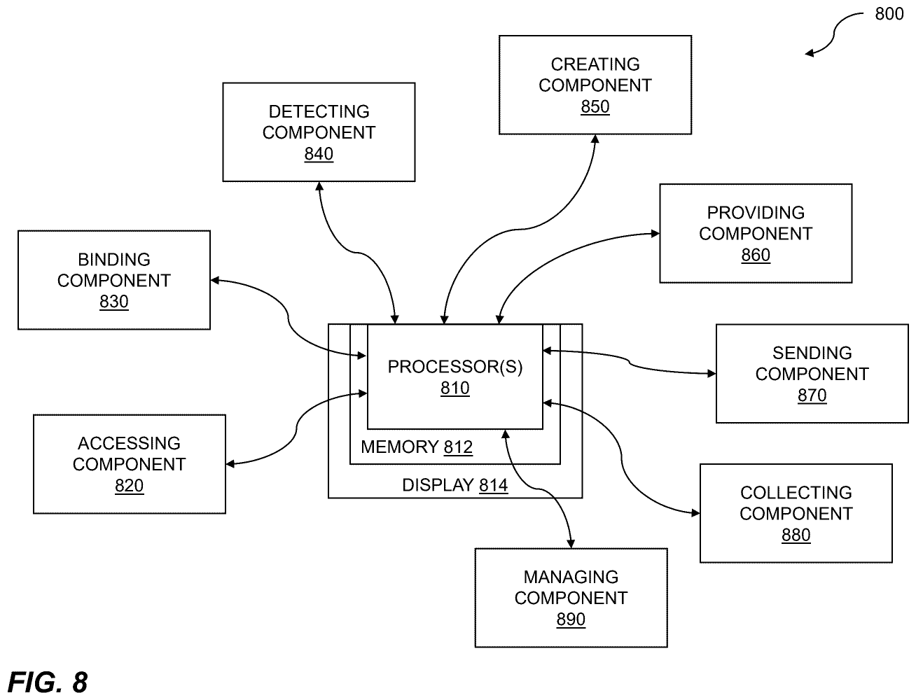

FIG. 8 is a system diagram for ecommerce product management using instant messaging. The system 800 can include one or more processors 810 coupled to a memory 812 which stores instructions. The system 800 can include a display 814 coupled to the one or more processors 810 for displaying data, video streams, videos, video metadata, synthesized images, synthesized image sequences, synthesized videos search results, sorted search results, search parameters, metadata, webpages, intermediate steps, instructions, and so on. In embodiments, one or more processors 810 are coupled to the memory 812 where the one or more processors, when executing the instructions which are stored, are configured to: access an instant messaging (IM) system, wherein the IM system interfaces between one or more customers and an ecommerce business entity, and wherein the IM system recognizes the ecommerce business entity as a valid instant messaging system identity; bind the ecommerce business entity identity to one or more back-office management systems within the ecommerce business entity; detect a product in an instant messaging thread between the ecommerce business entity and the one or more customers; create a product description page (PDP) by at least one of the one or more back-office management systems, based on the detecting a product; provide a PDP link for the PDP, by the at least one of the one or more back-office management systems, to the ecommerce business entity; send the PDP link, by the ecommerce business entity, to the one or more customers, using the IM system; collect one or more responses from the one or more customers, using the IM system; and manage products, by the ecommerce business, based on the PDP and one or more responses from the one or more customers, using the one or more back-office management systems.

The system 800 includes an accessing component 820. The accessing component 820 includes functions and instructions for accessing an instant messaging (IM) system, wherein the IM system interfaces between one or more customers and an ecommerce business entity, and wherein the IM system recognizes the ecommerce business entity as a valid instant messaging system identity. In embodiments, the IM system can operate on a website. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser running on the device. In embodiments, the IM system comprises an app running on a mobile device. The app can use HTTP, TCP/IP, or DNS to communicate with the Internet, web servers, cloud-based platforms, and so on. In embodiments, the ecommerce business entity can establish one or more identities that can be recognized on the IM system. Each IM system identity can access the same features and functions available in the IM system as a regular user.

In embodiments, the IM system can include a controller bot. The controller bot can interact with the ecommerce business entity using the one or more identities recognized by the IM system. The controller bot can receive commands for the IM system, and can apply system updates. The controller bot can upload photos, videos, and other files generated by the business entity and make them available to customers as part of IM system message threads. The controller bot can pass commands through the IM system to an inventory management system and/or an order management system.

The system 800 includes a binding component 830. The binding component 830 includes functions and instructions for binding the ecommerce business entity identity to one or more back-office management systems within the ecommerce business entity. In embodiments, the back-office management system comprises an inventory management system. The inventory management system can include information about products available for purchase from the ecommerce business entity. The information can include product descriptions; specifications; product comments by users, experts, and social media influencers; purchasing details; instructions for reservations; inquiry processing; and product ratings. The inventory management system can include photos and videos of products. In embodiments, the one or more ecommerce business IM identities can be set up as one or more users in the inventory management system. The IM system can be established as an input/output connection to the inventory management system so that the IM system can be used to submit inquiries to and receive responses from the inventory management system. In some embodiments, one or more proxy users can be established in the inventory management system so that customers in the IM system can submit inquiries to the inventory management system directly.

In embodiments, the back-office management system comprises an order management system. The order management system can include information about customers such as contact information, shipping addresses, product information, quantity information, and so on. In embodiments, the order management system can interface to the inventory management system so that updates can be sent to the inventory management system when order information is collected. In embodiments, the one or more ecommerce business IM identities can be set up as one or more users in the order management system. The IM system can be established as an input/output connection to the order management system, so that the IM system can be used to submit inquiries to and receive responses from the order management system. In some embodiments, one or more proxy users can be established in the order management system so that customers in the IM system can submit inquiries to the order management system directly.

The system 800 includes a detecting component 840. The detecting component 840 includes functions and instructions for detecting a product in an instant messaging thread between the ecommerce business entity and the one or more customers. In embodiments, the IM system can include a store bot. The store bot is an application included in the IM system. In embodiments, the store bot monitors the one-to-one and group message threads on the IM system and sends the thread contents to a machine learning model for analysis by one or more LLMs. In embodiments, the IM message thread can be analyzed by a machine learning system that includes a large language model. The LLM can be trained with voice and text interactions between users, human sales associates, help desk staff members, and product experts. Information articles and questions covering products and services offered for sale by the ecommerce business can be included in the LLM database. In embodiments, the LLM can include a natural language processing (NLP) engine. The large language model (LLM) uses NLP to understand the text and the context of messages in the IM interactions between the ecommerce business entity and customers. Each IM messaging thread can be analyzed by the LLM and can be used to recognize references to products and services offered for sale. In embodiments, the instant messaging thread is detected based on a photo of the product included in the thread. In some embodiments, the detecting is based on a product photo, a product video, or a product description. Metadata associated with product photos or videos can be used by the LLM to recognize references to products or services for sale by the ecommerce business entity.

The system 800 includes a creating component 850. The creating component 850 includes functions and instructions for creating a product description page (PDP) by at least one of the one or more back-office management systems, based on the detecting a product. In embodiments, the inventory management system generates the PDP. The PDP can include additional product details. The additional product details can include one or more of a name of the product, a description of the product, a price of the product, an availability of the product, a variation of the product, and an alternative to the product. In embodiments, the PDP is created by an inventory management back-office system. The PDP can contain multiple product photos or videos, product descriptions, specifications, dimensions, shipping times, and so on. The product information from the order management system and the inventory management system can be combined into a PDP template. The PDP template can be included in both management systems so that details from both can be included in a PDP generated by either system. In embodiments, the PDP can include photos, product details, videos, pricing, shipping, lead times, alternate products, related products, and so on. The PDP can include hypertext and links to external websites or web pages on the ecommerce business website.

The system 800 includes a providing component 860. The providing component 860 includes functions and instructions for providing a PDP link for the PDP, by the at least one of the one or more back-office management systems, to the ecommerce business entity. In embodiments, the PDP can be provided to the ecommerce business entity as a link, a PDF, file, and so on. The PDP can include links to the back-office order management system, the inventory management system, or both. The LLM can recognize text or image references to a product, automatically generate a PDP including all information related to the product available from the ecommerce business order management and inventory management systems, and send the PDP to the sales representative. The PDP can appear as a link, a PDF document, or a file in the IM messaging system. The sales representative can click on the PDP link, document, or file and use the product information to continue the interaction with the customer. In some embodiments, opening the PDP can automatically open the sales representative's access to the order management system and/or the inventory management system to allow for additional interaction with these systems. In cases where the sales representative is already accessing the back-office systems, the embedded links in the PDP can direct the back-office systems to the screens or pages containing information related to the product highlighted by the PDP.

The system 800 includes a sending component 870. The sending component 870 includes functions and instructions for sending the PDP link, by the ecommerce business entity, to the one or more customers, using the IM system. In embodiments, the ecommerce business entity can use the product information contained in the PDP to continue his or her interaction with the customer as well as to forward the PDP link to the one or more customers. The sales representative or customer support person can send and receive IM messages as the customer views the PDP information, answer questions, clarify details in the PDP, and so on. In embodiments, the PDP can comprise multiple products. The multiple products can comprise a campaign theme, wherein the campaign theme is created by the one or more back-office systems. In some embodiments, discounts or other sales incentives can be included in the PDP. The multiple product PDP can be based on more than one response in the IM message thread. In some embodiments, the multiple product PDP can include discount information related to one or more of the products included in the PDP.

The system 800 includes a collecting component 880. The collecting component 880 includes functions and instructions for collecting one or more responses from the one or more customers, using the IM system. In embodiments, the user can respond to the ecommerce business entity by typing a question or comment into the IM system. The user input can comprise video input collected by the IM system. The video input can include audio input which can be analyzed, recorded, and/or transformed by a speech-to-text converter. In embodiments, the order management system collects an order from the one or more responses. The order can be based on a reply, included in the one or more responses, to the PDP link. The reply can be processed by natural language processing (NLP). The IM messaging stream can be analyzed by the LLM as the interaction between the ecommerce business entity and the customer continues. The reply from the customer can contain an order for one or more products contained in the PDP. In embodiments, the one or more responses from the customer can initiate a transaction by an order management back-office system. The order management system can further comprise confirming, through the IM system, any product order contained in the one or more responses. In embodiments, the customer can respond with a request for additional information, ask for a reminder to review the product at a later time, inquire about a different product, look for additional or alternate discounts, and so on. The ecommerce business entity can respond with additional information, receive additional PDPs generated by the back-office systems, and so on in order to keep the interaction with the customer flowing.

The system 800 includes a managing component 890. The managing component 890 includes functions and instructions for managing products, by the ecommerce business, based on the PDP and one or more responses from the one or more customers, using the one or more back-office management systems. In embodiments, the one or more back-office systems can provide a checkout link, based on the one or more responses in the instant messaging thread. Based on the one or more back-office systems bound to the ecommerce business entity identity, one or more products included in the PDP can be purchased or scheduled for later purchase. Quantities, sizes, dimensions, specifications and so on can be entered into the order management or inventory management system as determined by the ecommerce business. Delivery and shipping information can be entered, pricing can be finalized, and payment can be made within the IM messaging system based on the binding to the back-office systems. In embodiments, the message thread is recorded by the LLM system for analysis and training in order to refine the contents of the PDPs, improve interactions with the customers, and suggest sales campaign themes to the ecommerce business.

The system 800 can include a computer program product embodied in a non-transitory computer readable medium for product management, the computer program product comprising code which causes one or more processors to perform operations of: accessing an instant messaging (IM) system, wherein the IM system interfaces between one or more customers and an ecommerce business entity, and wherein the IM system recognizes the ecommerce business entity as a valid instant messaging system identity; binding the ecommerce business entity identity to one or more back-office management systems within the ecommerce business entity; detecting a product in an instant messaging thread between the ecommerce business entity and the one or more customers; creating a product description page (PDP) by at least one of the one or more back-office management systems, based on the detecting a product; providing a PDP link for the PDP, by the at least one of the one or more back-office management systems, to the ecommerce business entity; sending the PDP link, by the ecommerce business entity, to the one or more customers, using the IM system; collecting one or more responses from the one or more customers, using the IM system; and managing products, by the ecommerce business, based on the PDP and one or more responses from the one or more customers, using the one or more back-office management systems.

The system 800 can include a computer system for product management comprising: a memory which stores instructions; one or more processors coupled to the memory, wherein the one or more processors, when executing the instructions which are stored, are configured to: access an instant messaging (IM) system, wherein the IM system interfaces between one or more customers and an ecommerce business entity, and wherein the IM system recognizes the ecommerce business entity as a valid instant messaging system identity; bind the ecommerce business entity identity to one or more back-office management systems within the ecommerce business entity; detect a product in an instant messaging thread between the ecommerce business entity and the one or more customers; create a product description page (PDP) by at least one of the one or more back-office management systems, based on the detecting a product; provide a PDP link for the PDP, by the at least one of the one or more back-office management systems, to the ecommerce business entity; send the PDP link, by the ecommerce business entity, to the one or more customers, using the IM system; collect one or more responses from the one or more customers, using the IM system; and manage products, by the ecommerce business, based on the PDP and one or more responses from the one or more customers, using the one or more back-office management systems.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flowchart diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for product management comprising:
accessing an instant messaging (IM) system, wherein the IM system interfaces between one or more customers and an ecommerce business entity, and wherein the IM system recognizes the ecommerce business entity as a valid instant messaging system identity;
binding the ecommerce business entity identity to one or more back-office management systems within the ecommerce business entity;
detecting a product in an instant messaging thread between the ecommerce business entity and the one or more customers;
creating a product description page (PDP) by at least one of the one or more back-office management systems, based on the detecting a product;
providing a PDP link for the PDP, by the at least one of the one or more back-office management systems, to the ecommerce business entity;
sending the PDP link, by the ecommerce business entity, to the one or more customers, using the IM system;
collecting one or more responses from the one or more customers, using the IM system; and
managing products, by the ecommerce business, based on the PDP and one or more responses from the one or more customers, using the one or more back-office management systems.

2. The method of claim 1 wherein the back-office management system comprises an inventory management system.

3. The method of claim 2 wherein the inventory management system generates the PDP.

4. The method of claim 1 wherein the instant messaging thread is detected based on a photo of the product included in the thread.

5. The method of claim 4 further comprising adding, to the instant messaging thread, additional product details.

6. The method of claim 1 wherein the PDP is created by an inventory management back-office system.

7. The method of claim 6 wherein the one or more responses initiate a transaction by an order management back-office system.

8. The method of claim 7 further comprising confirming, through the IM system, any product order contained in the one or more responses.

9. The method of claim 1 wherein the detecting is based on a product photo, a product video, or a product description.

10. The method of claim 1 further comprising suggesting, by the one or more back-office systems, a product description, based on the detecting.

11. The method of claim 1 further comprising providing, by the one or more back-office systems, a checkout link, based on the one or more responses in the instant messaging thread.

12. The method of claim 1 wherein the back-office management system comprises an order management system.

13. The method of claim 12 wherein the order management system collects an order from the one or more responses.

14. The method of claim 13 wherein the order is based on a reply, included in the one or more responses, to the PDP link.

15. The method of claim 14 wherein the reply is processed by natural language processing.

16. The method of claim 13 wherein the order is based on a copy/paste, included in the one or more responses, detailing customer contact information, product information, and quantity information.

17. The method of claim 13 further comprising updating a back-office inventory management system, by the order management system, based on the order that was collected.

18. The method of claim 1 wherein the PDP comprises multiple products.

19. The method of claim 18 wherein the multiple products comprise a campaign theme.

20. The method of claim 19 wherein the campaign theme is created by the one or more back-office systems.

21. The method of claim 18 wherein the multiple product PDP is based on more than one response.

22. A computer program product embodied in a non-transitory computer readable medium for product management, the computer program product comprising code which causes one or more processors to perform operations of:
accessing an instant messaging (IM) system, wherein the IM system interfaces between one or more customers and an ecommerce business entity, and wherein the IM system recognizes the ecommerce business entity as a valid instant messaging system identity;
binding the ecommerce business entity identity to one or more back-office management systems within the ecommerce business entity;
detecting a product in an instant messaging thread between the ecommerce business entity and the one or more customers;
creating a product description page (PDP) by at least one of the one or more back-office management systems, based on the detecting a product;
providing a PDP link for the PDP, by the at least one of the one or more back-office management systems, to the ecommerce business entity;
sending the PDP link, by the ecommerce business entity, to the one or more customers, using the IM system;
collecting one or more responses from the one or more customers, using the IM system; and
managing products, by the ecommerce business, based on the PDP and one or more responses from the one or more customers, using the one or more back-office management systems.

23. A computer system for product management comprising:
a memory which stores instructions;
one or more processors coupled to the memory wherein the one or more processors, when executing the instructions which are stored, are configured to:
access an instant messaging (IM) system, wherein the IM system interfaces between one or more customers and an ecommerce business entity, and wherein the IM system recognizes the ecommerce business entity as a valid instant messaging system identity;
bind the ecommerce business entity identity to one or more back-office management systems within the ecommerce business entity;
detect a product in an instant messaging thread between the ecommerce business entity and the one or more customers;
create a product description page (PDP) by at least one of the one or more back-office management systems, based on the detecting a product;
provide a PDP link for the PDP, by the at least one of the one or more back-office management systems, to the ecommerce business entity;
send the PDP link, by the ecommerce business entity, to the one or more customers, using the IM system;
collect one or more responses from the one or more customers, using the IM system; and
manage products, by the ecommerce business, based on the PDP and one or more responses from the one or more customers, using the one or more back-office management systems.
